(19) United States
(12) Patent Application Publication
(10) Pub. No.: US 2009/0066511 A1
(43) Pub. Date: Mar. 12, 2009

(54) INFORMATIONAL MANAGEMENT SYSTEM, LIVESTOCK MANAGEMENT SYSTEM AND CAGES

(75) Inventor: Naoki Okazaki, Yokohama (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/854,292

(22) Filed: Sep. 12, 2007

(30) Foreign Application Priority Data
Sep. 15, 2006 (JP) 2006-251306

(51) Int. Cl. G08B 13/14; H04Q 5/22

(52) U.S. Cl. 340/572.1; 340/10.4

(57) ABSTRACT

An information management system, livestock management system and cages with which chickens can be managed as individual units. A tag reader 8 communicates with a transponder 5 attached to chicken 2 in cage 1 through a passive antenna disposed on one surface of cage 1 so that the distance from transponder 5 is within a first predetermined distance and an active antenna 7 disposed on automatic feeder 4 so that the distance from passive antenna 6 when closest is within a second predetermined distance whereby power can be supplied using electromagnetic coupling, and reads management information for chicken 2 from transponder 5 or writes it to transponder 5. This information management system can be used for other livestock and for other moving objects.

### FIELD OF THE INVENTION

The present invention relates to an information management system, livestock management system and cages on a poultry farm.

On poultry farms, chickens are raised in cages on the order of several thousand or several tens of thousands. When a contagious illness such as avian influenza occurs, a life or death situation exists for the poultry farm. So managing the breeding history, vaccination information, health status, etc., for individual chickens is crucial for the poultry farm. However, managing several thousand or several tens of thousands of chickens one-by-one requires considerable effort.

The technology disclosed in Japanese Kokai Patent Application No. 2006-14925, for example, exists as technology for managing chickens on a poultry farm.

In Japanese Kokai Patent Application No. 2006-149253, a mortality estimation method is disclosed wherein the mortality number is estimated based on information on IC tags distributed in feed or IC tags prior to distribution, and information on IC tags in evacuated excrement by giving the chickens feed in which IC tags are distributed.

### BACKGROUND OF THE INVENTION

However, the technology disclosed in Patent Citation 1 is technology for estimating the proportion of chickens that have died within a large number of chickens, so it does not necessarily manage individual chickens. For example, it has the disadvantage that it is not possible to know which chickens in several thousand cages have died.

A general object of the present invention is to provide an information management system, livestock management system, and cages with which chickens can be managed as individual units.

### SUMMARY OF THE INVENTION

This and other objects and features are attained in accordance with one aspect of the information management system in the present invention having: a non-contact tag attached to a moving body that moves through a predetermined movement path, and a tag reading part furnished in the aforementioned movement path that can communicate with the aforementioned non-contact tag using electromagnetic induction when the distance from the aforementioned non-contact tag attached to the aforementioned moving body is within a first predetermined distance. The aforementioned tag reading part has: an active antenna that communicates with the aforementioned non-contact tag, a passive antenna disposed in a position electromagnetically coupled to the aforementioned active antenna for communicating with the aforementioned non-contact tag, and a tag reader that is coupled to the aforementioned active antenna and that reads information from the aforementioned non-contact tag or that writes information to the aforementioned non-contact tag.

An aspect of the information management system in the present invention may also have: a tag reading part attached to a moving body that moves through a predetermined movement path, and a non-contact tag furnished in the aforementioned predetermined movement path that can communicate with the aforementioned tag reading part using electromagnetic inductance when the distance from the aforementioned tag reading part attached to the aforementioned moving body is within a first predetermined distance. The aforementioned tag reading part has: an active antenna that for communicating with the aforementioned non-contact tag, a passive antenna disposed in a position electromagnetically coupled to the aforementioned active antenna for communicating with the aforementioned non-contact tag, and a tag reader that is coupled to the aforementioned active antenna and that reads information from the aforementioned non-contact tag or that writes information to the aforementioned non-contact tag.

An aspect of the present invention is a livestock management system having: multiple passive antennas attached to multiple cages housing livestock arranged side by side, a non-contact tag attached to the aforementioned livestock, an active antenna attached to an automatic feeder that moves along the aforementioned cages arranged side by side to supply feed, and a tag reader that is coupled to the aforementioned active antenna and that reads information from the aforementioned non-contact tag or that writes information to the aforementioned non-contact tag. The aforementioned non-contact tag and the aforementioned passive antennas can communicate using electromagnetic inductance when the distance between them is within a first predetermined distance, and the aforementioned active antenna and the aforementioned passive antennas are electromagnetically coupled when the distance between them is within a second predetermined distance.

In the livestock management system in the present invention, if the aforementioned livestock are chickens, the non-contact tag is may be attached to a leg of each of the chickens, the cage may have a rectangular shape, and the passive antennas may be furnished in the bottom surfaces of the cages.

The cage in the present invention may be a cage for housing livestock and a plurality is arranged side by side. A passive antenna can be arranged in the cage so that the distance from the non-contact tag attached to the livestock will be within a first predetermined distance to enable communication with the non-contact tag.

### BRIEF DESCRIPTION OF THE DRAWINGS

FIG. 1 is a diagram showing the constitution of poultry rearing management system 100.

FIG. 2 is a diagram for explaining electromagnetic coupling between passive antenna 6 and active antenna 7.

FIG. 3 is a diagram showing the size of a cage of normal size.

FIG. 4 is a diagram showing a concrete example of the relative positions of passive antenna 6 and active antenna 7.

FIG. 5 is a diagram showing a concrete example of the relative positions of passive antenna 6 and active antenna 7.

FIG. 6 is a diagram showing a concrete example of the relative positions of passive antenna 6 and active antenna 7.

FIG. 7 is a diagram showing the constitution of train detection system 200, which is a variation of the present invention.

### REFERENCE NUMERALS AND SYMBOLS AS SHOWN IN THE DRAWINGS

In the figures, 100 represents a poultry rearing management system, 1 a cage, 11 a tag reading part, 2 a chicken, 3 a feed trough, 4 an automatic feeder, 5 a transponder, 6 a passive antenna, 7 an active antenna, 8 a tag reader, 200 a train detection system, 201 a rail, 202 a train, 203 a tag, 204 a tag reader, 205 an active antenna, and 206, 207 are passive antennas.

### DESCRIPTION OF THE EMBODIMENTS

With the present invention, it is possible to provide an information management system, livestock management system and cages that can manage chickens as individual units.

One embodiment for implementing the invention

Below, a poultry rearing management system 100 in this embodiment is explained.

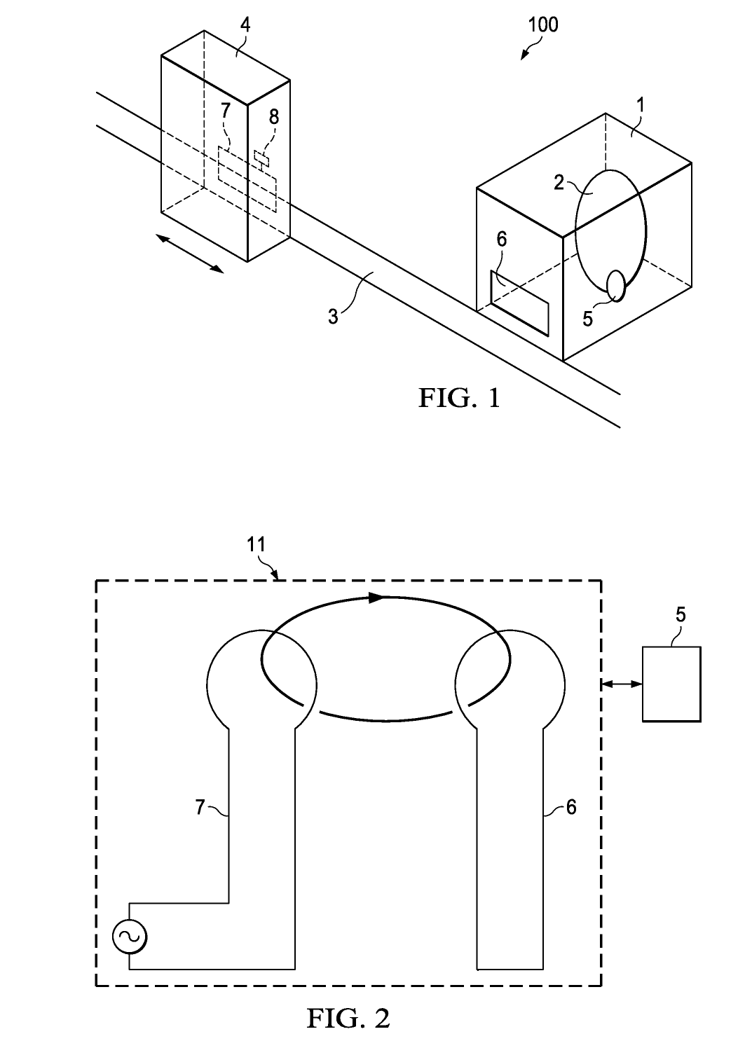

FIG. 1 is a diagram showing the constitution of poultry rearing management system 100.

As shown in FIG. 1, chicken 2 is raised in a cage 1. Cage 1 is disposed along a gutter-shaped feed trough 3, so that chicken 2 can eat the feed in feed trough 3 by extending its neck from inside cage 1. Here, in FIG. 1, only one cage 1 is drawn to simplify the explanation, but actually, multiple cages 1 are disposed aligned in the direction of feed trough 3, and at least one chicken 2 is placed in each cage 1.

On the opposite side of the cage and sandwiching feed trough 3 is an automatic feeder 4 that supplies feed to feed trough 3 while moving automatically. Automatic feeder 4 continues to move toward the front or to the back in FIG. 1 following the feed trough at a low speed while dropping feed into feed trough 3.

A transponder 5 (non-contact tag) is attached to a leg of chicken 2. Management information for chicken 2, for example, the date of birth of chicken 2, feeding information (how much feed it has been fed), vaccination information, and the like is recorded on transponder 5. Management information for chicken 2 recorded on transponder 5 is read by a tag reader 8 via a passive antenna 6 and an active antenna 7, or is written from tag reader 8 via passive antenna 6 and active antenna 7. Passive antenna 6, active antenna 7 and tag reader 8 are collectively called tag reading part 11.

Transponder 5 is an ID tag using RFID, and is a passive type. A passive tag is an RF tag that does not itself have a power source and that operates using an electromagnetic field from a reader as the energy source, and exchanges information with the reader. Because the power transmitted from the tag to the reader is very small, the reception distance of a passive tag is shorter than an active antenna (ID tag with built-in battery to generate radio waves itself), but it has the advantage that it is also more stable than an active antenna and can be used for a long time.

Tag reader 8 reads and writes management information for chicken 2 on transponder 5 through passive antenna 6 and active antenna 7.

Passive antenna 6 is an antenna that does not have a power source and does not electrically amplify the signals it receives from cage 1.

Active antenna 7 is an antenna that has a power source and electrically amplifies signals, and is a loop antenna attached to tag reader 8 as well as to automatic feeder 4.

With passive antenna 6 and active antenna 7, coupling due to electromagnetic coupling occurs (power is supplied) when they are close (that is, when automatic feeder 4 passes in front of cage 1). Because of this, tag reader 8 connected to active antenna 7 can read or write chicken management information on transponder 5.

Electromagnetic coupling between passive antenna 6 and active antenna 7 is explained referring to FIG. 2.

As shown in FIG. 2, current flows to active antenna 7, power is supplied to passive antenna 6 when active antenna 7 and passive antenna 6 produce coupling, and passive antenna 6 generates radio waves at a predetermined frequency (in this embodiment, assume 13.56 MHz) to communicate with transponder 5.

Passive antenna 6 generates electromagnetic waves (13.56 MHz) to transponder 5 attached to a leg of chicken 2 as a result of coupling with active antenna 7, and communicates. In order to communicate with transponder 5, passive antenna 6 must be disposed so that the distance from transponder 5 is within a first predetermined distance. The first predetermined distance is the threshold value for which communication with transponder 5 is possible and is determined by the frequency of the electromagnetic waves used for communication. With this embodiment, 13.56 MHz electromagnetic waves are used, and it has been learned from experience that the first predetermined distance in this case is about 30 cm.

In this embodiment, by attaching passive antenna 6 to the bottom of cage 1, the distance between passive antenna 6 and transponder 5 can always be kept at 30 cm or less, so communication is enabled with no problem as long as the cage is of ordinary size.

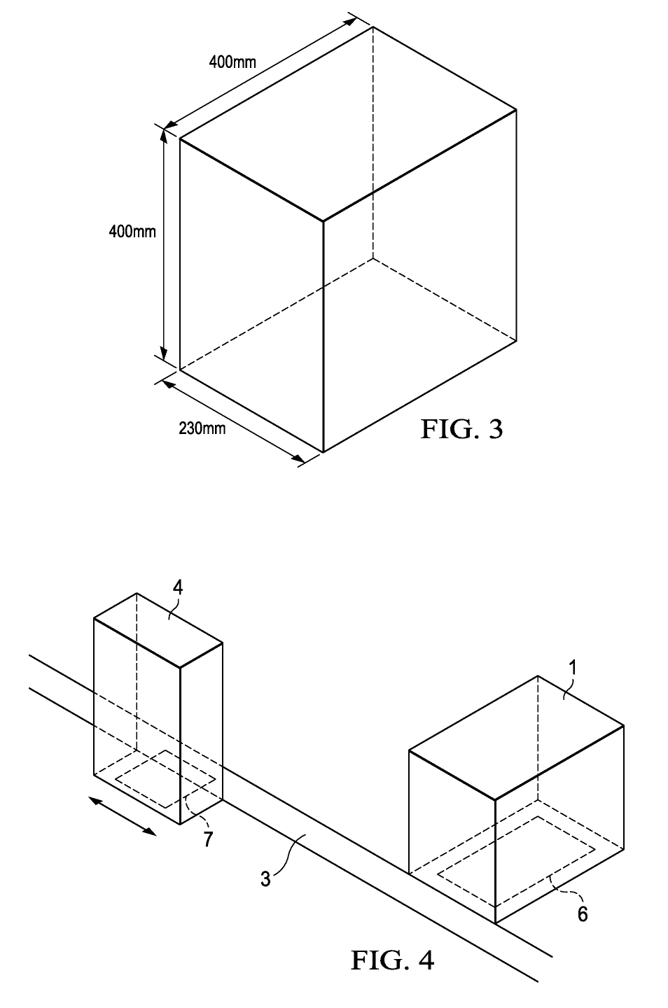

The size of a cage of ordinary size is shown in FIG. 3.

As shown in FIG. 3, a cage of ordinary size is 230 mm×400 mm×40 mm, so that by installing passive antenna 6 on the bottom of cage 1, a state wherein communication with transponder 5 attached to a leg of chicken 2 can occur can always be maintained even when chicken 2 moves inside cage 1.

Passive antenna 6 must be disposed in a position where communication with transponder 5 attached to a leg of chicken 2 in cage 1 is possible as described above, and, at the same time, it must be disposed in a position no more than a second predetermined distance at which the distance from active antenna 7 attached to automatic feeder 4 produces in coupling. The second predetermined distance is theoretically around 5-7 cm.

The position at which passive antenna 6 is installed is determined in order to satisfy these requirements for the first predetermined distance and the second predetermined distance.

Below, concrete examples of the installation positions of passive antenna 6 and active antenna 7 are explained.

FIGS. 4-6 are figures illustrating concrete examples of the installation positions of passive antenna 6 and active antenna 7.

In FIG. 4, passive antenna 6 is attached to the bottom surface of cage 1. Because transponder 5 is attached to a leg of chicken 2, the distance between transponder 5 and passive antenna 6 can be kept at no more than 30 cm, regardless of where chicken 2 is in cage 1, and the information recorded on transponder 5 can be read and written through passive antenna 6.

Active antenna 7 is attached horizontally to the bottom of automatic feeder 4. The active antenna is attached lower than the bottom surface of feed trough 3 and extends toward passive antenna 6 so that the distance from passive antenna 6 is no more than 5-7 cm when they again approach each other. Thus active antenna 7 can produce coupling with passive antenna 6.

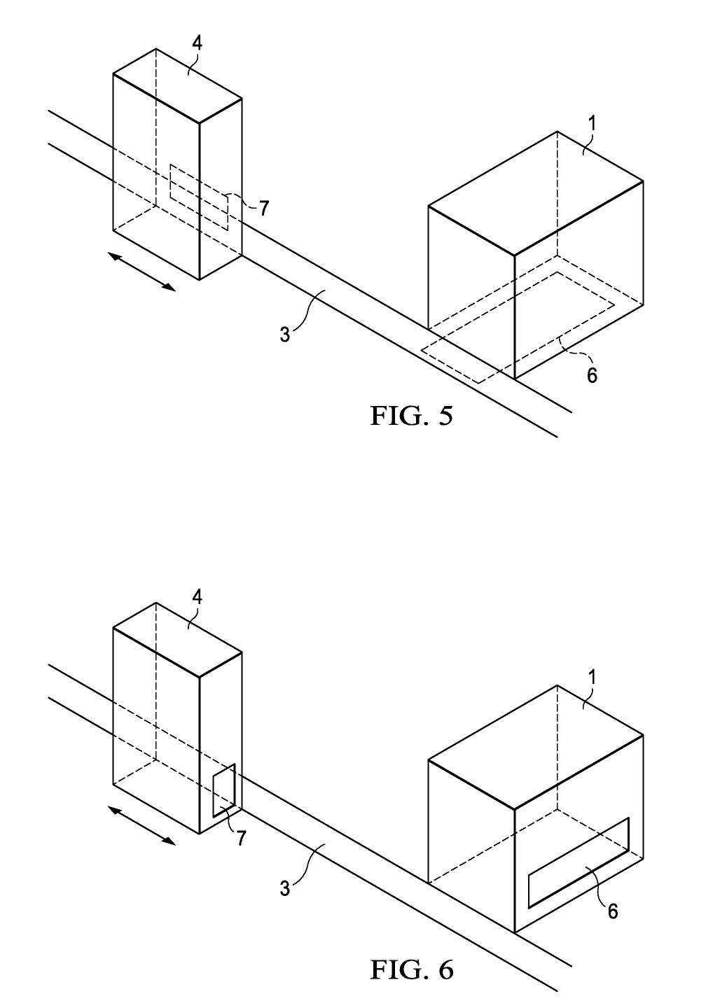

In FIG. 5, the location of attachment of passive antenna 6 to the bottom surface of cage 1 is the same as shown in FIG. 4, but because active antenna 7 is attached vertically to the bottom of automatic feeder 4, the distance between passive antenna 6 and active antenna 7 is greater. To compensate for this, passive antenna 6 extends toward automatic feeder 4 so that the distance between passive antenna 6 and active antenna 7 is no more than the second predetermined distance (5-7 cm) when they again approach each other.

In FIG. 6, passive antenna 6 is attached to the side surface of cage 1. As shown in FIG. 3, the lateral width of cage 1 (width in the direction of movement of the automatic feeder) is about 230 mm, so that even when passive antenna 6 is installed on either the left or right side surface, passive antenna 6 can communicate with transponder 5. Active antenna 7 is disposed on the side surface of automatic feeder 4 toward where passive antenna 6 is attached to cage 1 so that the distance from passive antenna 6 when they are close will be no more than the second predetermined distance.

As explained in FIGS. 4-6, passive antenna 6 may be attached in a position wherein the distance from transponder 5 attached to a leg of chicken 2 is no more than the first predetermined distance and active antenna 7 in a position on automatic feeder 4 wherein the distance from passive antenna 6 when they are close is no more than the second predetermined distanced.

As explained above, with poultry rearing management system 100 in this embodiment, tag reader 8 can read or write management information for chicken 2 on transponder 5 attached to a leg of chicken 2 through active antenna 7 and passive antenna 6. For this reason, by recording information relating to chickens 2 in cages 1 aligned in lateral rows on the order of from several hundred to several tens of thousands on transponders 5 attached to their legs, several thousand or several tens of thousands of chickens 2 can be management individually.

And with poultry rearing management system 100 in this embodiment, because active antenna 7 and tag reader 8 are attached to automatic feeder 4, information for chickens 2 in multiple cages 1 can be managed automatically, and the information can be managed with less labor than information management performed manually by a person for multiple cages.

And with poultry rearing management system 100 in this embodiment, because active antenna 7 connected to tag reader 8 and passive antenna 6 placed on cage 1 produce coupling using electromagnetic coupling, the information on transponder 5 is read by tag reader 8 utilizing this, so the communication distance can be extended as much as the passive antenna. That is, by just attaching an active antenna and a tag reader to the automatic feeder, information on a transponder attached to a chicken cannot be read when the chicken is at the back of the cage, but with poultry rearing management system 100 in this embodiment, such a disadvantage can be solved.

And with poultry rearing management system 100 in this embodiment, because existing cages 1 and automatic feeder 4 are used, it can be implemented simply. Because a passive antenna 6 that is inexpensive compared to active antenna 7 is disposed in each cage 1, the cost required for the overall system can be kept lower than when active antennas 7 are disposed in all cages and the information is managed with transponder 5 attached to a chicken 2.

The present invention is not limited to the embodiment described above.

That is, for implementation of the present invention, various modifications, combinations, sub-combinations and substitutions are possible relating to the component elements of the embodiment described above, within the technical scope or an equivalent scope of the present invention. For example, the present invention can also be applied to rearing facilities where livestock or the like other than chickens are reared in cages.

Note that with the embodiment described above, the wavelength (predetermined wavelength) of the electromagnetic waves used for communication between the antennas and transponder was 13.56 MHz, but the present invention is not limited to this. Because electromagnetic waves may be absorbed by the leg of a chicken 2 depending on the wavelength, this can be avoided, and the electromagnetic waves could also be in a frequency band that enables communication with tag reader 8 through passive antenna 6.

And in the embodiment described above, transponder 5 was attached to a leg of chicken 2, but the present invention is not limited to this. That is, transponder 5 could also be attached to the comb or a wing of chicken 2. And if transponder 5 is attached to the comb or a wing of chicken 2, passive antenna 6 could be disposed on the ceiling of cage 1, for example, and could be attached at a position so that the distance from transponder 5 to passive antenna 6 is always no more than the first predetermined distance.

With each of the embodiments described above, poultry rearing management system 100 with which multiple chickens can be managed individually was explained, but the present invention can also be applied to the variations described below.

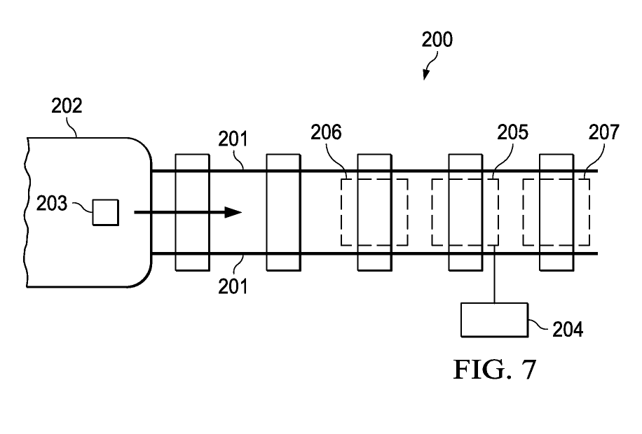

A variation of the present invention is a train car detection system 200 shown in FIG. 7.

FIG. 7 is a diagram showing the constitution of train detection system 200, which is a variation of the present invention.

With train detection system 200 that is a variation of the present invention, as shown in FIG. 7, a tag 203 is attached to a train 202 traveling on rails 201, and a tag reader 204, an active antenna 205 connected to tag reader 204, and passive antennas 206 and 207 are disposed below rails 201 at a point where passage of the train is detected.

By passage of train 202 traveling on rails 201 by the point where tag reader 204, active antenna 205 and passive antennas 206 and 207 are disposed, active antenna (205) produces coupling with passive antennas 206 and 207 using electromagnetic coupling in the same way as the embodiment of the present invention explained above, and tag reader 204 can read information with tag 203 attached to the train through active antenna 205 and passive antennas 206 and 207. In the case of this variation, information read and written to tag 203 is information relating to the train, for example, the time the point was passed, the number of cars, etc.

Active antenna 205 and passive antennas 206 and 207, as shown in FIG. 7, are disposed in the forward direction of train 202 in the sequence passive antenna, active antenna, passive antenna. The active antenna is disposed in the center so that current produced by electromagnetic coupling is produced toward both passive antennas 206 and 207 by active antenna 205. They are disposed in the forward direction of train 202 in order to increase the time that tag (203) can be captured by active antenna 205 and passive antennas 206 and 207, taking into consideration that the speed at which train 202 will pass is high. From this viewpoint, it is preferable that active antenna 205 and passive antennas 206 and 207 be long in the forward direction of train 202.

Note that with train detection system 200 in the variation described above, tag 203 is attached to train 202, and tag reader 204, active antenna 205 and passive antennas 206 and 207 are disposed below rail 201, but their placement could be the opposite. That is, the constitution could also be such that tag reader 204, active antenna 205 and passive antennas 206 and 207 are disposed on train 202, and tag 203 is attached at a point on rail 201 to detect the passage of train 202.

Instead of disposition of tag reader 204, active antenna 205 and passive antennas 206 and 207 below rail 201, they could also be disposed below or on the side of platform. In this case, they may be disposed so that the distance between tag 203, active antenna 205 and passive antennas 206 and 207 is within a predetermined distance when the train 202 and the antennas are closest.

And the variation of the present invention described above can also be applied to other than trains. That is, the present invention can be applied to an information management system that uses tags such that a tag is attached to a vehicle, person, pet, livestock or other moving object, and a tag reader and active antenna attached to it and a passive antenna that produces coupling with the active antenna are disposed in the movement path (or conversely, a tag reader and antennas are disposed on the moving object and a tag in the movement path).

While the invention has been particularly shown and described with reference to preferred embodiments thereof it is well understood by those skilled in the art that various changes and modifications can be made in the invention without departing from the spirit and scope of the invention as defined by the appended claims.

1. An information management system comprising:
a non-contact tag attached to a first moving body that moves through a first predetermined movement path,
and a tag reading part furnished in the movement path that can communicate with the non-contact tag using electromagnetic induction when the distance from the non-contact tag attached to the moving body is within a first predetermined distance;
and wherein the tag reading part has:
an active antenna that communicates with the non-contact tag,
a passive antenna disposed in a position electromagnetically coupled to the active antenna for communicating with the non-contact tag,
and a tag reader that is coupled to the active antenna and that reads information from the non-contact tag or writes information to the non-contact tag.

2. An information management system comprising:
a tag reading part attached to a moving body that moves through a predetermined movement path,
and a non-contact tag furnished in the predetermined movement path that can communicate with the tag reading part using electromagnetic inductance when the distance from the tag reading part attached to the moving body is within a first predetermined distance;
and wherein the tag reading part has:
an active antenna for communicating with the non-contact tag,
a passive antenna disposed in a position electromagnetically coupled to the active antenna for communicating with the non-contact tag,
and a tag reader that is coupled to the active antenna and that reads information from the non-contact tag or writes information to the non-contact tag.

3. A livestock management system that is a domestic management system comprising: multiple passive antennas attached to multiple cages housing livestock arranged side by side, a non-contact tag attached to the livestock, an active antenna attached to an automatic feeder that moves along the cages arranged side by side to supply feed, and a tag reader that is coupled to the active antenna and that reads information from the non-contact tag or writes information to the non-contact tag;
and wherein the non-contact tag and the passive antennas can communicate using electromagnetic inductance when the distance between them is within a first predetermined distance, and the active antenna and the passive antennas are electromagnetically coupled when the distance between them is within a second predetermined distance.

4. The livestock management system described in claim 3,
wherein the livestock are chickens,
the non-contact tag is attached to a leg of the chickens,
the cages have a rectangular shape,
and the passive antennas are attached to the bottom surfaces of the cages.

5. A cage for housing livestock and of which a plurality are arranged side by side comprising:
An enclosure; and a passive antenna furnished in the enclosure at a distance from a non-contact tag attached to the livestock in the enclosure will be within a first predetermined distance to enable communication with the non-contact tag.

6. The livestock management system described in claim 3,
wherein the livestock are chickens,
the non-contact tag is attached to a comb of the chickens,
the cages have a rectangular shape,
and the passive antennas are attached to the top surfaces of the cages.

7. The livestock management system described in claim 3,
wherein the livestock are chickens,
the non-contact tag is attached to a wing of the chickens,
the cages have a rectangular shape,
and the passive antennas are attached to the side surfaces of the cages.
